(19) United States
(12) Patent Application Publication
(10) Pub. No.: US 2013/0282562 A1
(43) Pub. Date: Oct. 24, 2013

(54) SYSTEMS AND METHODS FOR PREVENTING FRAUDULENT PURCHASES

(71) Applicants: Erika Gallo, Middletown, NJ (US); Rich Rezek, Zionsville, IN (US)

(72) Inventors: Erika Gallo, Middletown, NJ (US); Rich Rezek, Zionsville, IN (US)

(21) Appl. No.: 13/453,846

(22) Filed: Apr. 23, 2012

(51) Int. Cl. G06Q 20/38

(52) U.S. Cl. 705/39

(57) ABSTRACT

In one aspect, a computing apparatus is configured to monitor purchase transactions in accordance with rules and patterns learned in response to exposure to information relating to prior fraudulent transactions. A Fraud Alert Service (FAS) monitors and identifies possible fraud transactions based on stored data and learned behavioral patterns. The FAS integrates various entities to minimize financial loss to the entities due to fraudulent transactions through data integration, early detection, and timely notifications.

### BACKGROUND

Millions of transactions occur daily through the use of payment cards, such as credit cards, debit cards, prepaid cards, etc. Corresponding records of the transactions are recorded in databases for settlement and financial recordkeeping (e.g., to meet the requirements of individual entities). Such data can be combined and analyzed for trends, patterns, inconsistencies, and rule violations. Sometimes, such data can be used to identify both legitimate and fraudulent transactions.

### BRIEF DESCRIPTION OF THE DRAWINGS

The embodiments are illustrated by way of example and not limitation in the figures of the accompanying drawings in which like references indicate similar elements.

FIG. 1 is a chart showing a Fraud Alert System (FAS) in relation to commerce transaction components for facilitating transactions according to one embodiment;

FIG. 2 is a chart showing a FAS in relation to its commerce transaction components for blocking an account and notifying a merchant to not ship a fraudulently purchased item according to one embodiment;

FIG. 3 is a chart showing a FAS in relation to its commerce transaction components for validating an account and notifying a merchant to ship a legitimately purchased item according to one embodiment;

FIG. 4 is a chart showing a FAS in relation to its commerce transaction components for blocking an account and adding the account to a consortium negative file according to one embodiment;

FIG. 5 is a chart showing a FAS in relation to its commerce transaction components for validating an account and adding the account to a consortium positive tile according to one embodiment;

FIG. 6 is a chart showing a FAS in relation to its commerce transaction components for blocking an account and identifying related fraudulent accounts to a consortium negative file according to one embodiment;

FIG. 7 is a chart showing a FAS in relation to its commerce transaction components for blocking an account and issuing a credit to a merchant in the amount of the fraudulent transaction according to one embodiment;

FIG. 8 is a chart showing a FAS in relation to its commerce transaction components for writing rules for obtaining data that an Issuer does not presently have access to according to one embodiment;

FIG. 9 is a chart showing a FAS in relation to its commerce transaction components for validating Cardholder personal information and issuing an automated response for validation according to one embodiment; and

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

The following discussion is presented to enable a person skilled in the art to make and use embodiments of the invention. Various modifications to the illustrated embodiments will be readily apparent to those skilled in the art, and the generic principles herein can be applied to other embodiments and applications without departing from embodiments of the invention. Thus, embodiments of the invention are not intended to be limited to embodiments shown, but are to be accorded the widest scope consistent with the principles and features disclosed herein. The following detailed description is to be read with reference to the figures, in which like elements in different figures have like reference numerals. The figures, which are not necessarily to scale, depict selected embodiments and are not intended to limit the scope of embodiments of the invention. Skilled artisans will recognize the examples provided herein have many useful alternatives that fall within the scope of embodiments of the invention.

In some embodiments, transaction data, such as records of transactions made via credit accounts, debit accounts, prepaid accounts, bank accounts, stored value accounts and other accounts, is processed to provide information for various services, such as transaction settlement, generating statements, collections, spending analysis, pattern detection, fraud identification, fraud prevention, etc. In some embodiments, a Fraud Alert Service (hereinafter “FAS”) can be configured to communicate with independent entities responsible for transaction execution, transaction processing, and settlement. The FAS can collect, monitor, and provide data to the one or more entities so that greater amounts of information can be reviewed and/or analyzed based on a culmination of data that can be normally kept in a proprietary state among the independent entities. Through a culmination of data, the FAS can employ a rules database and neural systems to detect trends and identify possible fraudulent transactions at least partially based on a combination of combined data, defined trends, and cumulative neural learning from patterns potentially related to fraud.

Users of the FAS can attempt to prevent fraudulent transactions, can stop in-process fraudulent transactions, and can assist recovery efforts from successful fraudulent transactions. The FAS can use cumulative data to build a database to identify potentially fraudulent transactions based on data collected from prior fraudulent transactions. In some embodiments, the FAS can also streamline legitimate transitions by building a database of trusted data built from legitimate transactions occurring over a period of time.

In some embodiments, FAS rules can be defined by an Issuer, for example, in order to obtain access to data that is not commonly provided to an Issuer but is regularly collected by a merchant. At least a portion of the data can be used to identify suspicious transactions when combined with data known by the Issuer in order to more closely monitor suspicious transactions and/or terminating such transactions prior to such a transactions being completed.

In some embodiments, the neural systems of the FAS can learn to identify fraudulent transactions based on transactional patterns and conditions that might be difficult to detect for some conventional rules-based systems. Moreover, the neural systems can be configured to operate in evolving environments, such as where techniques and methods are in a continuous state of change in order to remain in front of detection techniques.

In general, the FAS can receives a first file comprising issuer transactions relating to a plurality of Cardholder authorization transactions and receives a second file comprising merchant transactions relating to a plurality of Cardholder sale transactions. The FAS can locate a first corresponding account record in the issuer transactions that includes a match to a data point in a second corresponding account record in the merchant transactions. In some embodiments, the FAS can compare the first corresponding account record to the second corresponding account record to determine if a mismatched data field exists, and the FAS can add the account data associated with first corresponding account record and the second corresponding account record to a negative account file when the mismatched field exists.

In one embodiment, the FAS can be configured to provide Merchants better access to Issuer information and fraud information, which Issuers can be made aware of either through the Cardholder or Merchant reporting activities. The FAS can improve upon some conventional methods. For example, some conventional systems can comprise a Merchant conducting fraud verification by placing a call to the bank and/or a call the Cardholder, which can be an error-prone and time consuming process.

Moreover, for many conventional systems, a fraud charge-back can take up to thirty days to be settled. In one embodiment, the FAS can reduce the amount of time by providing a file to the Issuers immediately identifying potential fraud. In some embodiments, the file can include an indication that they provided a valid authorization for the transaction. For example, when the Merchant accepts the credit card information from the Cardholder, the information can be authorized or approved through the issuing bank; however, the FAS can access negative data in a Global Consortium Negative Database that can correspond to the credit card information. As such, the FAS can be aware that the transaction is fraudulent and can provide this information to the Merchant, such that the Merchant can cancel the transaction or attempt to intercept an item if the Merchant previously shipped the item.

In some embodiments, the FAS can comprise one or more modules that can be configured to exchange information and files with the FAS. A module can be configured for the Merchant, for example, to exchange files with the FAS to communicate suspicious activities. As used herein, the term “fraud alert” refers to data that reports a final disposition of a Cardholder purchase order that was previously evaluated by a real-time or near real-time risk management service of a shield module or a card Issuer.

For example, in some embodiments, a transaction can be verified and appear to be legitimate by a Merchant or Issuer. Moreover, information specifically corresponding to the transaction data may not be located in the Global Consortium Negative Database. Nevertheless, the Merchant using the FAS may still determine that the account associated with the transaction is fraudulent and deny or cancel the transaction as a result, and further, send this information to the Issuer.

In some embodiments, the FAS can comprise additional criteria that can be used to identify fraudulent transactions that can be defined by a set of rules that are present in a “Code 10 Initial File” and a “Code 10 Final File.” The file naming conventions presented herein are for explanation only, and a system providing the disclosed features may include names and file formats in accordance with standards and preferences of the implementer.

In some embodiments, the “Code 10 Initial File” can provide notification to Issuers that there is a suspicion associated with Cardholder's payment card number or transaction. The Issuer can use this information, for example, to initiate a more-detailed investigation of the account in order to block additional fraudulent activities. Activities and/or situations that might trigger “suspicion” can include, for example, a mismatch between billing and shipping address information or the Cardholder's credit card number may be associated with prior confirmed fraudulent transactions, as indicated by any of the systems and methods disclosed herein. In one embodiment, suspicion can be determined when a management service recommends a review and users of the fraud detection system have confirmed a transaction as being fraudulent.

In one embodiment, a “Code 10 Final Response File” can provide at least two functions for communication from an Issuer. A first function can be configured to respond to a challenge response that can be sent by the FAS or the Merchant on the account/transaction. In one embodiment, a second function can notify the FAS network of participating merchants, wherein the notification can indicate that a Cardholder's credit card number may have been compromised, for example.

In some conventional systems, Issuers can have access only to information related to the Cardholder's payment account, so that the Merchant frequently has access to much more information relating to the Cardholder. Although the Issuer may have the Cardholder's billing information, the Merchant can have the Cardholder's various shipping addresses, work address, alternative phone numbers, email addresses, computer IP address, etc. For example, it may be advantageous for the Issuer to be aware of the Cardholder's IP address not matching an IP address at either the billing or shipping address. Such information may be of use to Issuers in order to reduce fraud, but under normal circumstances, they do not have access to any of this information that can be a part of a typical authorization stream. In one embodiment, the FAS is configured to process rules that prompt the Issuer to indicate whether or not they authorize a transaction in addition to the Merchant's authorization of that transaction.

In one embodiment, the FAS can be configured to process rules relating to the Cardholder in order to collect specific data and can send the Cardholder data to a FAS subscriber to perform fraud verification. In some embodiments, fraud verification may be triggered by a transaction appearing suspect, as described above, yet there is no certainty that the transaction is fraudulent. In some embodiments, the Cardholder data that is sent out to the Issuer can recapture different criteria such so the transaction may can be confirmed as fraud to the FAS Global Consortium Negative Database. Accordingly, the related transaction can be denied or canceled.

In one embodiment, a fraudulent transaction can comprise an order that a FAS Merchant discovered to be fraudulent through fraud verification of the Cardholder, a suspect transaction based on defined rules, and/or data that the FAS has stored in its various systems. The Issuer can send the FAS a response file to identify the account as being fraudulent.

In one embodiment, the FAS can confirm whether a reported account is associated with a fraudulent transaction. Confirmation can serve a check on the FAS (e.g., although a transaction may appear suspect and has been reported to the FAS, but a more thorough investigation of the Cardholder concludes that the transaction was actually a good transaction). In one embodiment, the above process can occur within about 24 hours of the Cardholder data initially being sent to the Issuer.

In some embodiments, the first file comprises the previously mentioned Cardholder data, and a second file comprises a fraud alert. In one embodiment, Merchants associated with the FAS can be assigned a merchant identification number. For example, a Merchant that desires to settle a transaction at a bank can use the unique merchant identification number, which can enable the Issuer to know where they need to send the settlement funds. Also, when a Cardholder makes a purchase, the merchant identification number can be attached to the transaction.

As previously mentioned, a more thorough investigation can occur when there is suspicion of fraud. For example, in the time that it requires to perform the more thorough investigation, it is likely that the transaction has been completed and the product has been shipped or somehow otherwise acquired by the fraud perpetrator. Therefore, the product cannot be retrieved and a chargeback is required.

A current procedure for processing a chargeback is as follows. For example, a bank may have previously authorized a transaction (e.g., authorized yesterday). Today, the customer reports that that he did not make the purchase because his or her credit card was stolen earlier in the day. Therefore, the transaction was fraudulent. In response to the Cardholder's claim, the Issuer can set a flag on the account that identifies the account as being fraudulent or will simply tag certain transactions within the account as being fraudulent. This can occurs before the chargeback process is initiated. It typically requires between 30 to 60 days for a chargeback to be sent to a Merchant or for the Merchant to be made aware that a chargeback has occurred on that account.

Contrary to the extended process described above, the fraud alert process of the FAS, can be configured so that it requires only a more limited time period (e.g., one or more days) in order for the FAS to issue a credit after being made aware of transactions that are fraudulent. The FAS can move the fraud information into the Global Consortium Negative Database and the FAS can create global blocks based on the physical address associated with the order, the email address, and any other identifiable data points into the Global Consortium Negative Database. If fraud behaviors are occurring on an account, the FAS flags some or all of that transactional data as fraud, so that blocks are placed in the system to prevent execution of any attempted subsequent orders.

In order to isolate fraudulent accounts and/or transactions, the FAS can identify a fraud pattern, can recognize that the FAS was not aware of the fraud until one or more days after it occurred, for example. In some embodiments, the FAS administrator can adjust the FAS neural model, change the risk strategy, and can change the fraud model to adapt to the fraud behaviors. Moreover, in some embodiments, rather than waiting 30 or 60 days for the chargeback, as in at least some conventional systems, the FAS can substantially reduce that time by bypassing the traditional process, which includes notifying and waiting on action from the Issuer, the Acquirer, and/or the Merchant. For example, the FAS can significantly reduce and simplify the chargeback process by communicating with the card Issuer directly.

In some conventional systems, fraud reduction companies exist to facilitate the sharing of negative transaction data. However, such companies have not implemented global consortium blocks to prevent fraud behaviors from occurring at other Merchants within their network (i.e., fraud reduction companies generally do not use fraud data from a first Merchant to prevent fraud from occurring at other Merchants). Further, there are presently few or no companies that use fraud information to integrate within and train neural models and/or risk strategy to adapt to fraud trends within short frames of time. In general, there are presently no processes that can use such information for proactively preventing future incidents of fraud. In some embodiments, the FAS can facilitate the insertion of file information into neural components in order to teach or coach the neural models based upon consistently evolving behaviors. This results in dynamic, real-time fraud detection and decisioning due to the continuous learning of behaviors that is occurring within the FAS neural systems.

In one embodiment, the FAS can be configured to alert the Merchant to suspect transactions through the implementation of rules that are written for the Issuer. In some embodiments, the Issuer can request that the FAS administrator write rules specific to data that is presently lacking. For example, if the billing and shipping information does not match, an order is over $200, or the order is for a “high-risk” product, then the Issuer can perform verification, resulting in a Code 10 Final Response File that the Issuer will either approve or reject. If they reject it, the FAS can alert and advise the Merchant to attempt to stop shipment of the order. If the order has already been shipped, the Merchant will be advised to attempt to intercept the order prior to delivery. If the rejected transaction related to a digital download such as, for example, a virtual gift card, then the Merchant may void the virtual gift card so that it is of no value.

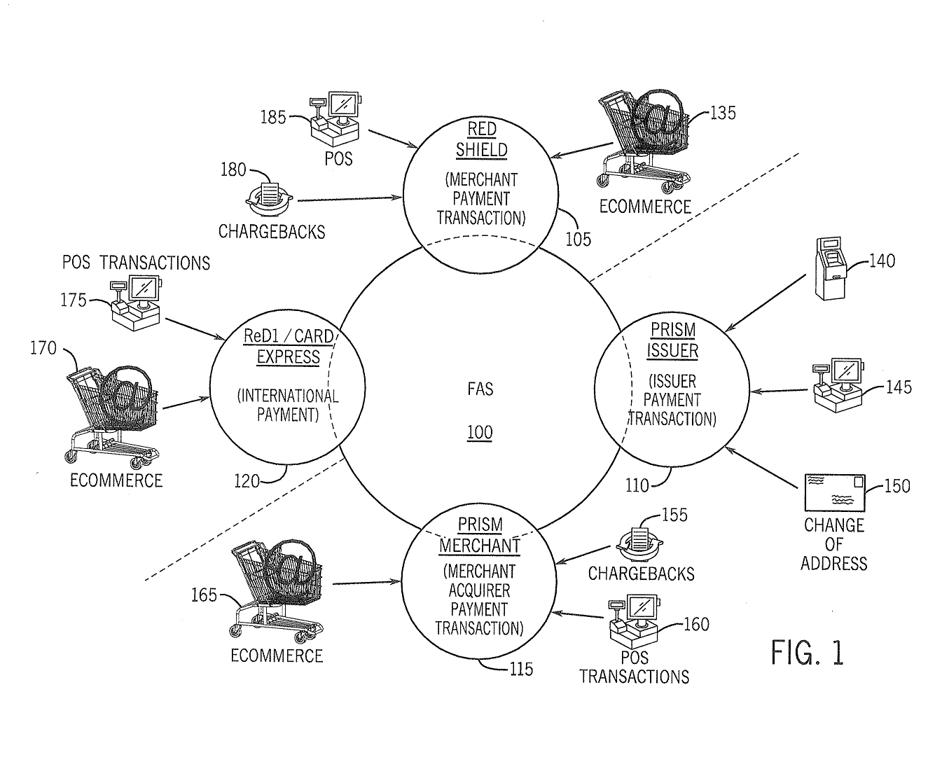

FIG. 1 is a chart showing the relationship between the FAS 100 and its components in accordance with some embodiments of the invention. In some embodiments, the components can include an Merchant Payment Transaction 105, an Issuer Payment Transaction 110, a Merchant Acquirer Payment Transaction 115, and an International Payment 120. As illustrated, at least a portion of the commerce components can receive various inputs in response to providing the features, wherein each of the inputs can be subject to, or can result from, fraudulent transactions. For example, at least some of the inputs relating to or triggering the Merchant Payment Transaction 105 can originate from an Ecommerce 125 transaction and a Point of Sale (POS) 185 transaction. The Merchant Payment Transaction 105 can also include Chargeback 180 transactions that can result from fraudulent transactions, for example.

In some embodiments, the Issuer Payment Transaction 110 commerce component may originate based on inputs from an Automated Teller Machine (ATM) 140 transaction, POS 145 transaction, and change of address 150 transaction. In some embodiments, the Merchant Acquirer Payment Transaction 115 can receive inputs and can perform transactions based on data originating from an Ecommerce 165 transaction, POS 160 Transaction, or a Chargeback 155 transaction. An International Payment can comprise an Ecommerce 170 transaction and a POS 175 transaction.

In some embodiments, because the FAS 100 can interact and/or communicate with at least some of these aspects of the financial transaction relationship, the FAS 100 is able to implement the disclosed processes due to its relationships, primarily with the Issuer and the Merchant. Because the FAS 100 can be configured to intercede one behalf of one or both entities for the benefit of each, the entities can be more comfortable with a closer integration and sharing of information.

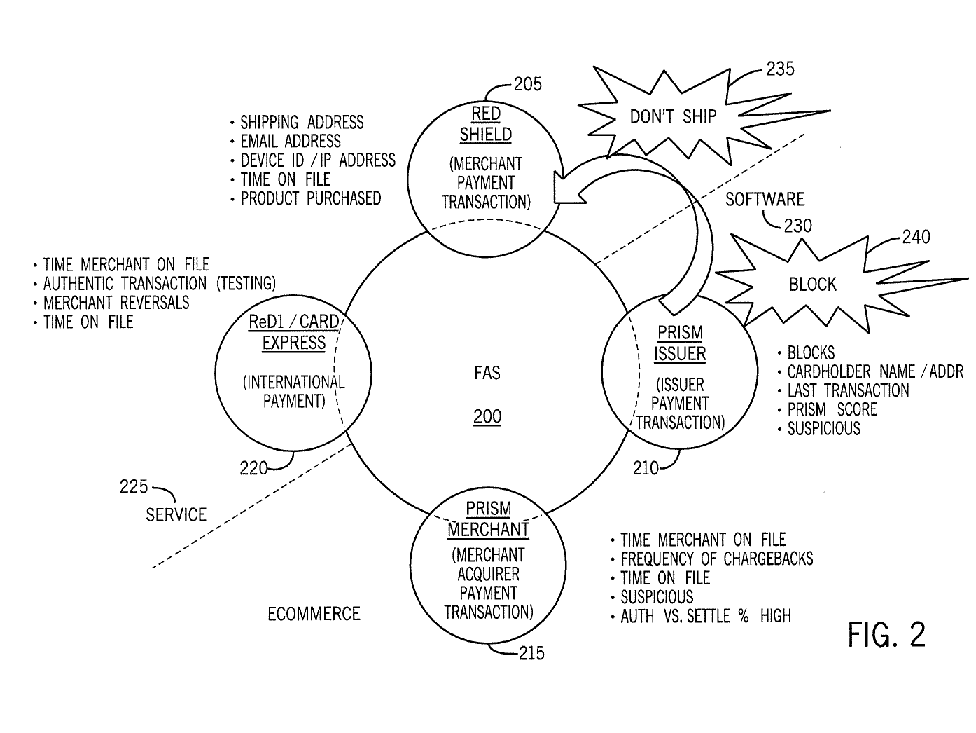

FIG. 2 is a chart showing the FAS 200 in relation to its commerce transaction components for blocking an account and notifying a merchant to not ship a fraudulently purchased item, according to some embodiments of the invention. The commerce transaction components include the Merchant Payment Transaction 205, the Issuer Payment Transaction 210, the Merchant Acquirer Payment Transaction 215, and the International Payment 220. Issuers are very limited in the amount of data to which they have access. For example, in some conventional systems, the merchant has a quantity of information limited only by what the merchant does and does not require and/or acquire from the Cardholder during the payment process. Therefore, the Issuer can be at a disadvantage when it comes to making decisions about the potential occurrence of fraud based on collected data. Basically, the Issuer is limited to the information that is included in the authorization stream, which can include the credit card number, at least a portion of the shipping address or the billing address.

In some embodiments, the FAS 200 can provide a Code 10 file to the Issuer. The code 10 file can enable the Issuer to locate an account number in the file that can correspond to an account number that the Issuer would like to validate. For example, in some embodiments, if the corresponding account number is found, the Issuer can check the corresponding data to ensure that the account name matches the account name that the Issuer has on record. If there is not a match, then the file record can be flagged so that the Issuer can perform a fraud verification. In some embodiments, the Code 10 file can also contain the phone number that was provided in the checkout page of the Merchant site. If the Issuer determines that this phone number does not match the phone number that the Issuer has on the account, then the entry can flagged.

Although other fraud detection systems share negative files, this practice can be limited in that the only determination that may be made is whether or not an account is “bad.” For example, this conventional process does not reveal that the account is bad because the phone number does not match a phone number that the Issuer has on file. Having information in addition to whether a file is good or bad provides for an ability to perform a relatively thorough analysis (i.e., there may be a reason for the phone numbers not matching, other than the account being fraudulent).

In some embodiments, the FAS 200 can provides a merchant interface that can include a link that allows verification (e.g., real-time or near real-time verification) of transaction data by comparing data from the Merchant's check-out and/or payment page to account information maintained by the Issuer. Such a link can alleviate the need for transporting files back and forth over a network. Moreover, many online Merchants employ fraud analysts that are alerted when an online order is placed. The fraud analyst can access information relating to the order and contact the Cardholder who submitted the order. Often times, the fraud analyst will also call the bank to ensure that the given account is valid. This practice may be considered counterintuitive, in that it counters some of the benefits of “online” shopping.

In some embodiments, in order to eliminate the need for the Issuer to place a call to the Cardholder and to the Cardholder's bank, the FAS 200 can provide an interface, which can allow the analyst to perform a fraud verification by selecting a link within the interface that executes a command to compare the data from the checkout page to the data that the Issuer has on file for the Cardholder. In some embodiments, there the FAS can function with little or no need for continuous monitoring by a human fraud analyst. The verification can occur substantially or completely automatically, and can alert an analyst via text message, email, or other conventional communication methods, if fraud is detected.

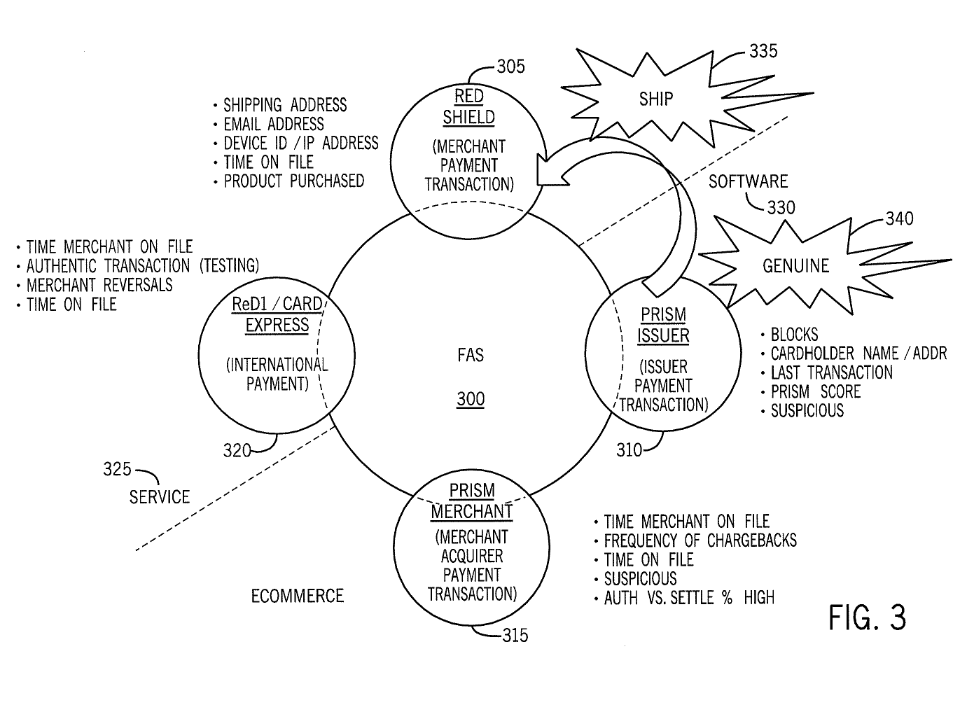

FIG. 3 is a chart showing the FAS 300 in relation to its commerce transaction components for validating an account and notifying a merchant to ship a legitimately purchased item, according to some embodiments. The commerce transaction components include the Merchant Payment Transaction 305, the Issuer Payment Transaction 310, the Merchant Acquirer Payment Transaction 315, and the International Payment 320. In some embodiments, if a process, that is as thorough as some previously mentioned embodiments, is performed to ensure that fraud is not occurring within the Merchant's online environment, then the Merchant can be notified that they can have confidence in executing the shipping process, because this has been verified by a human to be a positive profile. Although the Cardholder can be associated with information that appears suspect, it has been determined that the Cardholder is legitimate. As such, in some embodiments, the Merchant can be confident in shipping to an address that is different than the billing address, if that is what the Cardholder is requesting, for example.

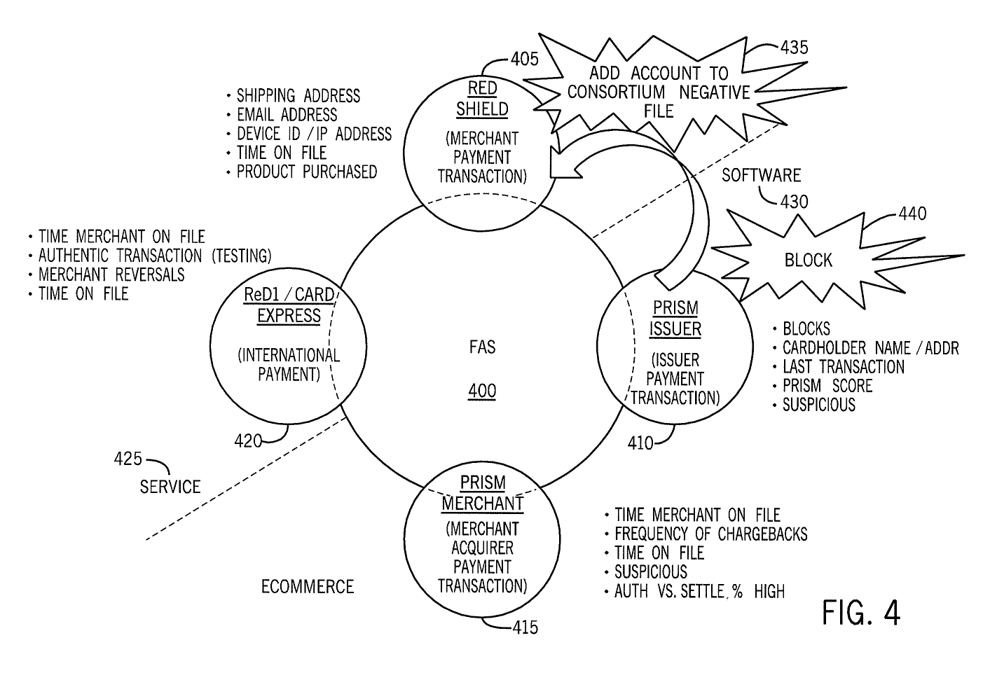

FIG. 4 is a chart showing the FAS 400 in relation to its commerce transaction components for blocking an account and adding the account to a consortium negative file according to some embodiments. In some embodiments, the commerce transaction components can include the Merchant Payment Transaction 405, the Issuer Payment Transaction 410, the Merchant Acquirer Payment Transaction 415, and the International Payment 420. In some embodiments, if Cardholder data is found to be negative, then FAS 400 may add the account information for the associated Cardholder to the Global Consortium Negative Database. Moreover, in some embodiments, the addition of this and other accounts to the Global Consortium Negative Database need not apply only to the one Merchant that encountered the fraud attempt, but for some or all FAS Merchants. Some or all fraudulent transactions can be stopped early in the commercial process and the Issuer does not need to consume at least some time and resources to perform the fraud verification step or transmit files over the network for validation.

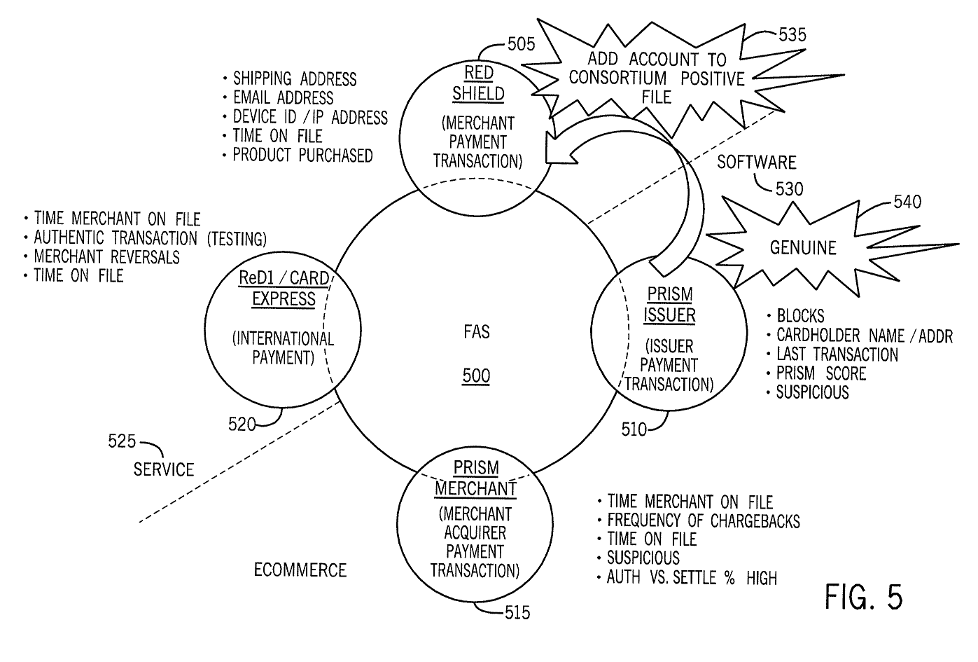

FIG. 5 is a chart showing the FAS 500 in relation to its commerce transaction components for validating an account and adding the account to a consortium positive file according to some embodiments. In some embodiments, the commerce transaction components can include the Merchant Payment Transaction 505, the Issuer Payment Transaction 510, the Merchant Acquirer Payment Transaction 515, and the International Payment 520. In some embodiments, similar to negative information being added to a consortium negative file, at least a portion of some positive information relating to a verified Cardholder can be added to a positive profiling database. In some embodiments, some Cardholders can be associated with positive information, which can enable confidence in Merchants that makes it safe and efficient to pass through fraud verification. By way of example only, in some embodiment, if the Cardholder has been scrutinized in accordance with predefined criteria in the past, then the Issuer can avoid continued scrutiny of the Cardholder, like a first-time Cardholder.

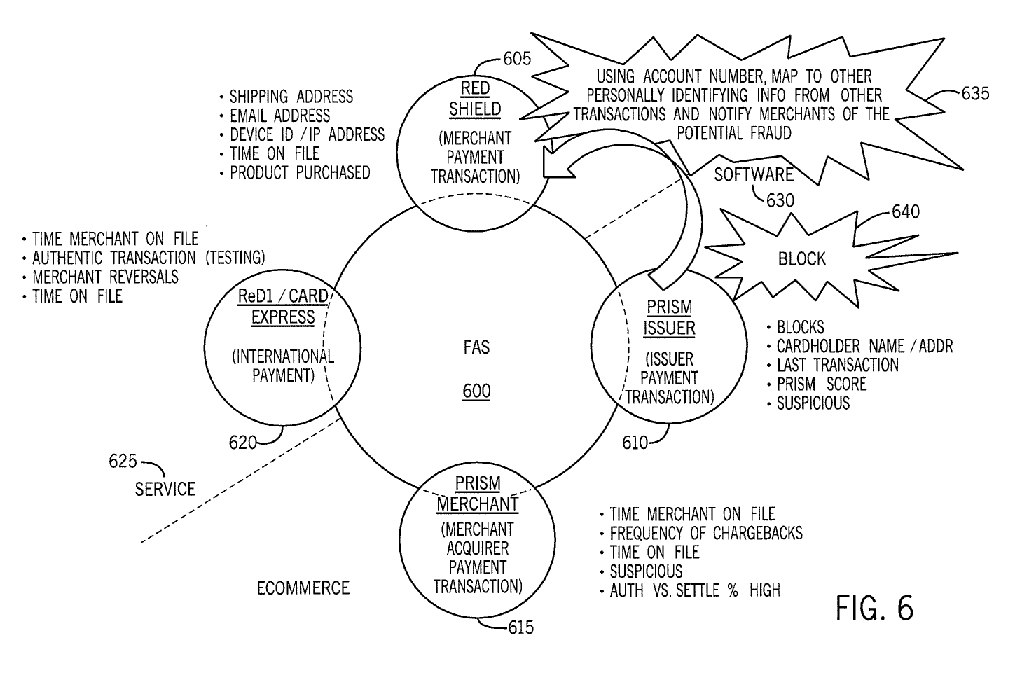

FIG. 6 is a chart showing the FAS 600 in relation to its commerce transaction components for blocking an account and identifying related fraudulent accounts to a consortium negative file according to some embodiments. In some embodiments, the commerce transaction components can include the Merchant Payment Transaction 605, the Issuer Payment Transaction 610, the Merchant Acquirer Payment Transaction 615, and the International Payment 120. In one embodiment, the FAS 600 can place a block 640 on the Issuer and can use the account number to map other personally identifying information from other transactions and can notify other merchants of the potential fraud 635. As a result, in some embodiments, the same fraudster who may be using multiple identities from executing additional fraudulent transactions can be prevented from fraudulently obtaining merchandise or services from multiple Merchants using the same or similar payment methods.

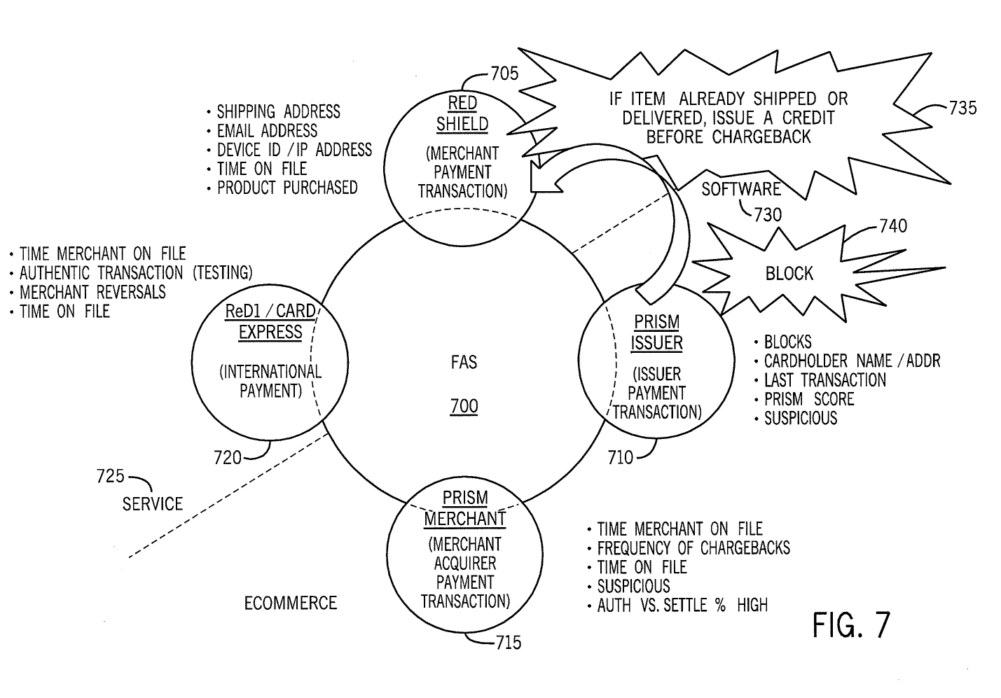

FIG. 7 is a chart showing the FAS 700 in relation to its commerce transaction components for blocking an account and issuing a credit to a merchant in the amount of the fraudulent transaction according to some embodiments. In some embodiments, the commerce transaction components can include the Merchant Payment Transaction 705, the Issuer Payment Transaction 710, the Merchant Acquirer Payment Transaction 715, and the International Payment 720. For example, when the FAS 700 detects fraud, it can issue a block 740 at the Issuer 710 to prevent authorization of some or all transactions including data associated with the data of the detected fraud. In some embodiments, if the Merchant 705 has already shipped or delivered the purchased item based on the fraudulent transaction, FAS 700 can issue a credit, which can takes one or more days, before processing a chargeback, which can take from more time 735.

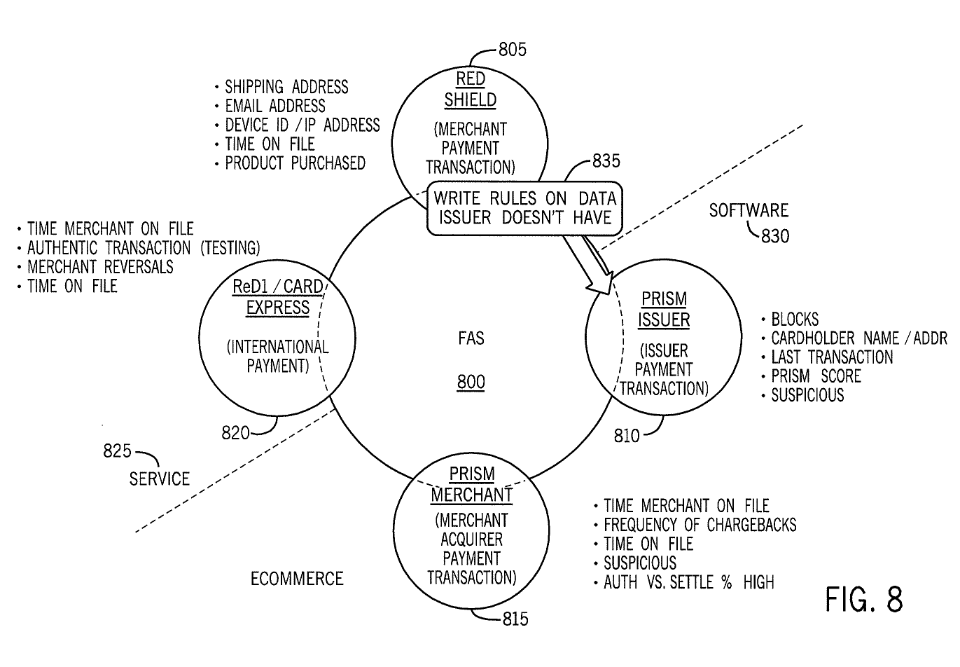

FIG. 8 is a chart showing the FAS 800 in relation to its commerce transaction components for writing rules for obtaining data that an Issuer does not presently have access to according to some embodiments. In some embodiments, the commerce transaction components can include the Merchant Payment Transaction 805, the Issuer Payment Transaction 810, the Merchant Acquirer Payment Transaction 815, and the International Payment 820.

As previously mentioned, in some embodiments, the Issuer 810 can be limited in the amount of data to which it has access, which can place the Issuer 810 at a disadvantage in detecting fraud. For example, the Merchant 805, on the other hand, can receive, store, and/or have access to a large amount of data that can collected from the Merchant's check-out page on their web site. In some embodiments, this information can include, for example, billing addresses, shipping addresses, the Cardholder's name, telephone numbers, employment information, banking information, email addresses, etc. Therefore, it can be more feasible for the Merchant 805 to detect inconsistencies in the data provided by the Cardholder, which may be indicative of fraud. Therefore, in some embodiments, the FAS 800 can make a subset of the Merchant's 805 data also available to the Issuer 810 by enabling rules to be written regarding data that the Issuer may not presently have.

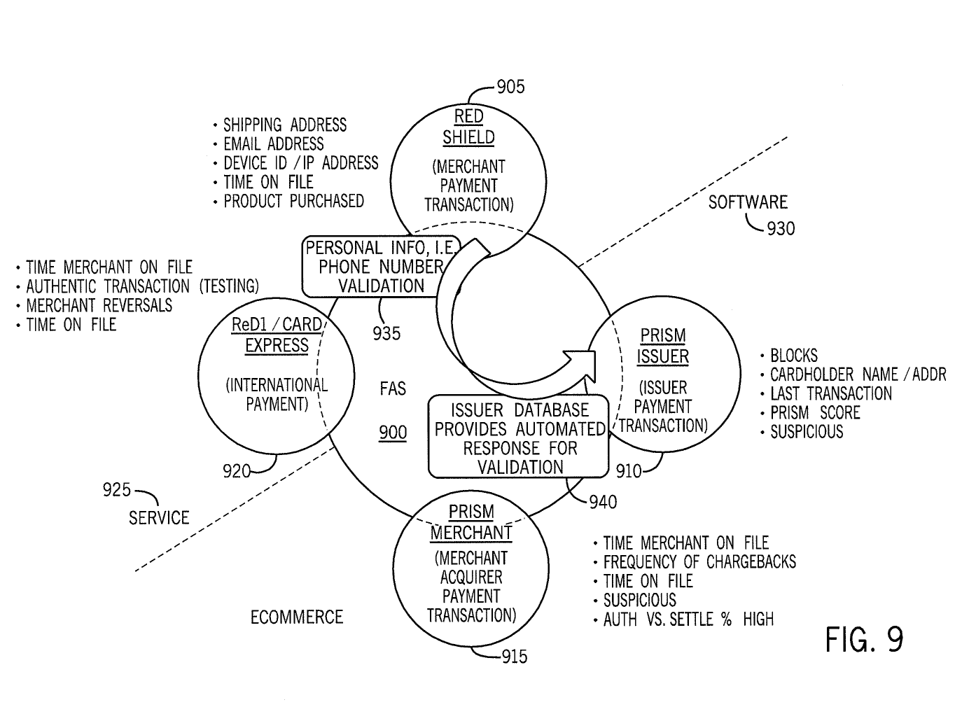

FIG. 9 is a chart showing the FAS 900 in relation to its commerce transaction components for validating Cardholder personal information and issuing an automated response for validation according to some embodiments. In some embodiments, the commerce transaction components can include the Merchant Payment Transaction 905, the Issuer Payment Transaction 910, the Merchant Acquirer Payment Transaction 915, and the International Payment 920.

In some embodiments, when an order is placed on the Merchant's web site, the information can be transmitted to the Issuer 910 for authorization. The information submitted by the Merchant 905 can include data specific to the Cardholder and the Cardholder's account. For example, information that is personal to the Cardholder, such as a phone number, can be transmitted to the Issuer 910 for automated validation. In some embodiments, this information can be verified against data in the Issuer's database, which can provide an automated response for validation in return.

As previously mentioned, some embodiments of the present invention may be practiced with various computer system configurations including hand-held devices, microprocessor systems, microprocessor-based or programmable consumer electronics, minicomputers, mainframe computers and the like. The invention can also be practiced in distributed computing environments where tasks are performed by remote processing devices that are linked through a wire-based or wireless network.

With the above embodiments in mind, it should be understood that the invention can employ various computer-implemented operations involving data stored in computer systems. These operations are those requiring physical manipulation of physical quantities. Usually, though not necessarily, these quantities take the form of electrical or magnetic signals capable of being stored, transferred, combined, compared and otherwise manipulated.

Any of the operations described herein that form part of the invention are useful machine operations. The invention also relates to a device or an apparatus for performing these operations. The apparatus may be specially constructed for the required purpose, such as a special purpose computer. When defined as a special purpose computer, the computer can also perform other processing, program execution or routines that are not part of the special purpose, while still being capable of operating for the special purpose. Alternatively, the operations may be processed by a general purpose computer selectively activated or configured by one or more computer programs stored in the computer memory, cache, or obtained over a network. When data is obtained over a network the data may be processed by other computers on the network, e.g. a cloud of computing resources.

The embodiments of the present invention can also be defined as a machine that transforms data from one state to another state. The data may represent an article, that can be represented as an electronic signal and electronically manipulate data. The transformed data can, in some cases, be visually depicted on a display, representing the physical object that results from the transformation of data. The transformed data can be saved to storage generally or in particular formats that enable the construction or depiction of a physical and tangible object. In some embodiments, the manipulation can be performed by a processor. In such an example, the processor thus transforms the data from one thing to another. Still further, the methods can be processed by one or more machines or processors that can be connected over a network. Each machine can transform data from one state or thing to another, and can also process data, save data to storage, transmit data over a network, display the result, or communicate the result to another machine. Computer-readable storage media, as used herein, refers to physical or tangible storage (as opposed to signals) and includes without limitation volatile and non-volatile, removable and non-removable storage media implemented in any method or technology for the tangible storage of information such as computer-readable instructions, data structures, program modules or other data.

Some portions of the invention can also be embodied as computer readable code on a computer readable medium. The computer readable medium may be any data storage device that can store data, which can thereafter be read by a computer system. Examples of the computer readable medium include hard drives, network attached storage (NAS), read-only memory, random-access memory, FLASH based memory, CD-ROMs, CD-Rs, CD-RWs, DVDs, magnetic tapes, other optical and non-optical data storage devices, or any other physical or material medium which can be used to tangibly store the desired information or data or instructions and which can be accessed by a computer or processor. The computer readable medium can also be distributed over a network coupled computer systems so that the computer readable code may be stored and executed in a distributed fashion.

Although the method operations were described in a specific order, it should be understood that other operations may be performed in between operations, or operations may be adjusted so that they occur at slightly different times, or may be distributed in a system which allows the occurrence of the processing operations at various intervals associated with the processing, as long as the processing of the overlay operations are performed in the desired way.

It will be appreciated by those skilled in the art that while the invention has been described above in connection with particular embodiments and examples, the invention is not necessarily so limited, and that numerous other embodiments, examples, uses, modifications and departures from the embodiments, examples and uses are intended to be encompassed by the invention.

### Other Aspects

The description and drawings are illustrative and are not to be construed as limiting. Numerous specific details are described to provide a thorough understanding. However, in certain instances, well known or conventional details are not described in order to avoid obscuring the description. References to one or an embodiment in the present disclosure are not necessarily references to the same embodiment; and, such references mean at least one.

The use of headings herein is merely provided for ease of reference, and shall not be interpreted in any way to limit this disclosure or the following claims.

Reference to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, and are not necessarily all referring to separate or alternative embodiments mutually exclusive of other embodiments. Moreover, various features are described which may be exhibited by one embodiment and not by others. Similarly, various requirements are described which may be requirements for one embodiment but not other embodiments. Unless excluded by explicit description and/or apparent incompatibility, any combination of various features described in this description is also included here.

The disclosures of the above discussed patent documents are hereby incorporated herein by reference.

In the foregoing specification, the disclosure has been described with reference to specific exemplary embodiments thereof It will be evident that various modifications may be made thereto without departing from the broader spirit and scope as set forth in the following claims. The specification and drawings are, accordingly, to be regarded in an illustrative sense rather than a restrictive sense.

1. A non-transitory computer-readable storage medium storing computer-readable instructions, which when executed, cause a fraud verification system to perform steps comprising:
receiving and storing on a computer-readable storage medium a first file comprising issuer transactions relating to a plurality of cardholder authorization transactions;
receiving and storing on a computer-readable storage medium a second file comprising merchant transactions relating to a plurality of cardholder sale transactions;
establishing real-time communication between a merchant and an issuer for electronic commerce cardholder purchase transactions;
locating a first corresponding account record in the issuer transactions that includes a match to a data point in a second corresponding account record in the merchant transactions or other issuer transactions;
comparing the first corresponding account record to the second corresponding account record to determine if a mismatched data field exists;
adding the account data associated with first corresponding account record and the second corresponding account record to a negative account file when the mismatched field exists;
receiving one of the purchase requests from a merchant, wherein the purchase request includes purchase account data;
comparing the purchase account data to the negative account file;
identifying an account match by determining whether a purchase account data element matches a negative account file data element; and
immediately sending a decline message to the merchant when the account match exists, allowing the merchant to cancel to transaction or intercept an item if the item has been shipped.

2. (canceled)

3. The method of claim 1, further comprising:
inserting a block indicia corresponding to the account match in at least on of: the first file and the second file; and
sending a notification to a merchant associated with the second file identifying a first transaction in the plurality of cardholder sale transactions is fraudulent.

4. The method of claim 1, further comprising:
inserting a block indicia corresponding to the account match in at least on of: the first file and the second file;
locating an account number from the account match;
searching the second file using the account number; and
sending a notification to a merchant associated with the second file identifying a second transaction in the plurality of cardholder sale transactions is fraudulent.

5. The method of claim 3, further comprising:
receiving an delivery notification relating to the first transaction from the merchant; and
issuing a credit to the merchant in the amount of the first transaction.

6. The method of claim 3, further comprising:
receiving a data request from an issuer, wherein the data request includes at least one selection of a merchant maintained data type that the issuer desires access to; and
providing the issuer with the access to the merchant maintained data type, wherein the issuer uses the merchant maintained data type as a search criteria for locating fraudulent transactions.

7. The method of claim 1, wherein a neural network is used to determine whether a fraud pattern exists based on the comparing.

8. The method of claim 1, wherein the first file is received from an issuer and the second file is received from a merchant.

9. A non-transitory computer-readable storage medium storing computer-readable instructions, which when executed, cause a fraud verification system to perform steps comprising:
receiving a first file comprising issuer transactions relating to a plurality of cardholder authorization transactions;
receiving a second file comprising merchant transactions relating to a plurality of cardholder sale transactions;
locating a first corresponding account record in the issuer transactions that includes a match to a data point in a second corresponding account record in the merchant transactions;
comparing the first corresponding account record to the second corresponding account record to determine if a mismatched data field exists;
determining if multiple matches exist between the first corresponding account record and the second corresponding account record when the mismatched data field does not exist;
determining whether a number of the multiple matches is equal to or greater than an predefined transaction count;
adding the account data associated with first corresponding account record and the second corresponding account record to a positive account file when the mismatched field exists;
establishing real-time communication between a merchant and an issuer for electronic commerce cardholder purchase transactions;
receiving a purchase transaction request from a merchant, wherein the purchase request includes purchase account data;
comparing the purchase account data to the positive account file;
identifying an account match by determining whether a purchase account data element matches a positive account file data element; and
immediately sending an accept message to the merchant when the account match exists.

10. (canceled)

11. The method of claim 9, further comprising:
inserting a block indicia corresponding to the account match in at least on of: the first file and the second file; and
sending a notification to a merchant associated with the second file identifying a first transaction in the plurality of cardholder sale transactions is fraudulent.

12. The method of claim 9, further comprising:
inserting a block indicia corresponding to the account match in at least on of: the first file and the second file;
locating an account number from the account match;
searching the second file using the account number; and
sending a notification to a merchant associated with the second file identifying a second transaction in the plurality of cardholder sale transactions is fraudulent.

13. A non-transitory computer-readable storage medium storing computer-readable instructions, which when executed, cause a fraud verification system to:
receive a first file comprising issuer transactions relating to a plurality of cardholder authorization transactions;
receive a second file comprising merchant transactions relating to a plurality of cardholder sale transactions;
locate a first corresponding account record in the issuer transactions that includes a match to a data point in a second corresponding account record in the merchant transactions;
compare the first corresponding account record to the second corresponding account record to determine if a mismatched data field exists;
add the account data associated with first corresponding account record and the second corresponding account record to a negative account file when the mismatched field exists;
receive a purchase request from a merchant, wherein the purchase request includes purchase account data;
compare the purchase account data to the negative account file in real time:
identify in real time an account match by determining whether a purchase account data element matches a negative account file data element; and
immediately send a decline message to the merchant when the account match exists to allow the merchant to cancel the transaction or intercept an item if the item has been shipped.

14. (canceled)

15. The storage medium of claim 13, wherein the instructions further cause the fraud verification system to:
insert a block indicia corresponding to the account match in at least on of: the first file and the second file; and
send a notification to a merchant associated with the second file identifying a first transaction in the plurality of cardholder sale transactions is fraudulent.

16. The storage medium of claim 13, wherein the instructions further cause the fraud verification system to:
insert a block indicia corresponding to the account match in at least on of: the first file and the second file;
locate an account number from the account match;
search the second file using the account number; and
send a notification to a merchant associated with the second file identifying a second transaction in the plurality of cardholder sale transactions is fraudulent.

17. The storage medium of claim 16, wherein the instructions further cause the fraud verification system to:
receive an delivery notification relating to the first transaction from the merchant; and
issue a credit to the merchant in the amount of the first transaction.

18. The storage medium of claim 16, wherein the instructions further cause the fraud verification system to:
receive a data request from an issuer, wherein the data request includes at least one selection of a merchant maintained data type that the issuer desires access to; and
provide the issuer with the access to the merchant maintained data type, wherein the issuer uses the merchant maintained data type as a search criteria for locating fraudulent transactions.

19. The storage medium of claim 16, wherein a neural network is used to determine whether a fraud pattern exists based on the comparing.

20. The storage medium of claim 16, wherein the first file is received from an issuer and the second file is received from a merchant.
